(19) United States
(12) Patent Application Publication
(10) Pub. No.: US 2018/0067717 A1
(43) Pub. Date: Mar. 8, 2018

(54) VOICE-DRIVEN INTERFACE TO CONTROL MULTI-LAYERED CONTENT IN A HEAD MOUNTED DISPLAY

(71) Applicant: Allomind, Inc., Arcadia, CA (US)

(72) Inventors: ABHIJIT LIMAYE, Arcadia, CA (US); THEOBOLT LEUNG, Arcadia, CA (US); NIRAV VASA, Arcadia, CA (US)

(73) Assignee: Allomind, Inc., Arcadia, CA (US)

(21) Appl. No.: 15/696,046

(22) Filed: Sep. 5, 2017

Related U.S. Application Data
(60) Provisional application No. 62/383,379, filed on Sep. 2, 2016.

(51) Int. Cl. G06F 3/16; G06T 19/00; G10L 15/22; G10L 15/08; G06F 17/30

(52) U.S. Cl. CPC G06F 3/167; G06T 19/006; G10L 15/22; G06F 3/04815; G06F 17/30864; G06F 17/30876; G10L 15/08

(57) ABSTRACT

The present disclosure relates to user interfaces for virtual reality and augmented reality head mounted displays. One embodiment of the present disclosure involves: (i) initializing an application instance for interacting with multi-layered media content output to a head-mounted display; (ii) receiving digitized speech and processing the digitized speech to extract text; (iii) comparing one or more words from the extracted text with a predefined keyword list to determine a response identifier; (iv) determining if the response identifier matches a response identifier stored in a database; and (v) if the response identifier matches a response identifier stored in the database, triggering an action in the application instance or retrieving from the database metadata associated with a media layer of the multi-layered media content.

### RELATED APPLICATIONS

This application claims the benefit of U.S. Provisional Patent Application No. 62/383,379, filed on Sep. 2, 2016, the content of which is incorporated herein by reference in its entirety.

### TECHNICAL FIELD

The present disclosure relates generally to head mounted displays, and more particularly, to user interfaces for virtual reality and augmented reality head mounted displays.

### BACKGROUND

Virtual reality (VR) head mounted displays (HMDs) allow for the visual experience of physical environments: existing, computer-generated, or non-terrestrial, or other than the actual location of the subject viewing the experience. There are several ways a user can interact with media content within the context of a VR environment including body movement, hand movement, head movement, and eye tracking.

In most cases, the interactions described above require specific hardware to capture the intended movement of the viewer. This requirement can force the viewer to behave unnaturally while using the device. For example, a controller may have a latency that requires the user to move at a particular pace in order to get the desired interaction results from that particular system. Likewise, in the case of capture of eye motion, the hardware requires such a level of sophistication and production that development becomes cost prohibitive to create an optimum experience without a margin of error. There is also the risk that existing eye motion capture systems generally only work within a limited range of distance, under certain light conditions.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 illustrates an exemplary communication environment in which embodiments disclosed herein may be implemented for providing a voice-driven UI to control multi-layered VR or AR content in a HMD.

FIG. 2 is a conceptual diagram illustrating a plurality of media layers, each having an associated effects layer.

FIG. 3 illustrates a three visual media layer configuration, including a rectangular field of view, a 360-degree panoramic field of view, and a 360-degree spherical field of view, that may be implemented in embodiments.

FIG. 4 is a block diagram illustrating an example architecture for components of the head mounted display and device of FIG. 1.

FIG. 5 illustrates example components of a voice UI application, including a voice module, a response module, and a database, in accordance with embodiments.

FIG. 6 is an operational flow diagram illustrating an example process that may be implemented by the voice module of the application of FIG. 5.

FIG. 7 is an operational flow diagram illustrating an example process that may be implemented by the response module of the application of FIG. 5.

FIGS. 8A-8D illustrate an example voice-driven user interface for a HMD in which embodiments disclosed herein may be implemented.

FIG. 9 illustrates an example computing module that may be used to implement various features of the methods disclosed herein.

The figures are not exhaustive and do not limit the disclosure to the precise form disclosed.

### DETAILED DESCRIPTION

To date, virtual reality (“VR”) and augmented reality (“AR”) head mounted displays (“HMD”) do not provide a voice-controlled context sensitive model for users to dynamically traverse and interact with multi-layered content. Although voice recognition techniques have been applied on desktop and mobile systems, such techniques generally perform basic tasks such, for example, retrieving specific types of data, playing music, making to-do lists, setting alarms, streaming podcasts, playing audiobooks, and providing weather, traffic and other real time information. Accordingly, current voice recognition techniques as applied on desktop and mobile devices do not provide much beyond passive consumption of media content.

Embodiments of the technology disclosed herein are directed to systems and methods for providing a user of a HMD a context sensitive voice-driven interface to control and interact with multi-layered content in VR, AR, or mixed reality (“MR”) environments. In accordance with embodiments, the HMD may output an audio, visual, or haptic user interface (UI) on its one or more displays as an overlay to multi-layer content. For example, speech interaction may be provided with multi-layered content, including: text, graphics, documents, web pages, videos, audio tracks, 360 degree videos, live video streams, live audio streams, games, video conferences, virtual classrooms and other VR or AR content. In embodiments, the UI overlay may provide contextual information (e.g., cues) to guide the user to employ voice-driven natural language, commands or keywords to control, query or otherwise interact with the content. In some embodiments, user speech recognition and natural language understanding of the user's speech may be invoked off the HMD (e.g., using a mobile device communicatively coupled to the HMD) as a means of interacting with the multi-layered media displayed by the HMD.

In various implementations, further described below, each of the media layers of the multi-layered content may be encoded as separate data channels (e.g., separate data streams). For example, separate channels may be encoded for voice audio, music audio, audience commentary, maps, video, text overlay, data visualization, environmental information, olfactory information, etc. In this manner, indexed keyword search commands may be stored and accessed with respect to the various channels, thereby permitting contextually based vocal cues and commands that are tied to a respective media layer.

As used herein, the term “augmented reality” or “AR” generally refers to presenting digital information to a user that is directly registered to the user's physical, real-world environment such that the user may interact with it in real time. The digital information may take the form of images, sound, video, text, haptic feedback, olfactory feedback, or other forms. For example, the digital information may appear as a three-dimensional object that is overlaid over the user's physical environment in real-time, or as an audio commentary. As described herein, the term “augmented reality” may be used interchangeably with the term “mixed reality.”

As used herein, the term “virtual reality” or “VR” generally refers to placing a user within (e.g., displaying) a completely computer-generated environment.

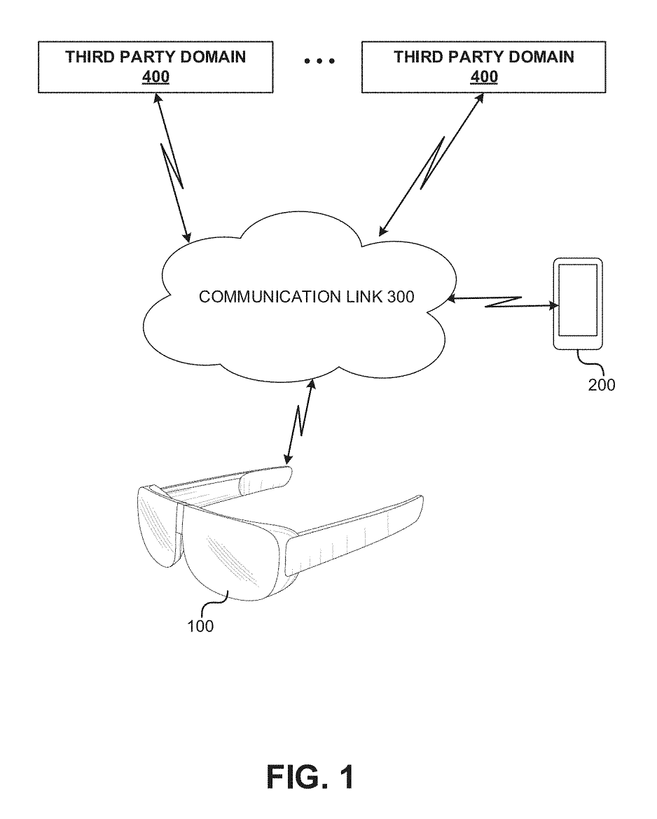

FIG. 1 illustrates an exemplary communication environment in which embodiments disclosed herein may be implemented for providing a voice-driven UI to control multi-layered VR or AR content in a HMD. In this example environment, data processing tasks related to creation and interaction with the VR/AR environment, including speech recognition and natural language understanding of voice commands are offloaded to device 200. In other embodiments, HMD 100 may implement some or all data processing tasks related to creation and interaction with the VR/AR environment (e.g., speech recognition and natural language interaction).

Communication link 300 may provide communication between HMD 100 and device 200 using any number of wireless networks, such as: a cellular or data network, a satellite network, a local area network (LAN), a wide area network (WAN), a BLUETOOTH network, a ZIGBEE network, a personal area network (PAN), or any combination thereof. For example, in one embodiment, a BLUETOOTH communication link is provided between HMD 100 and device 200. In further embodiments, a wired communication link may be provided between HMD 100 and device 200. Device, 200, in embodiments, may comprise a smartphone, a tablet, a laptop, a game console, a workstation, a local or remote server, or a wearable device such as a smartwatch.

Communication link 300 may also provide communication between HMD 100 or device 200 and third party domains 400 that may store media content (multi-layered or otherwise) and metadata relating to multi-layered content. In embodiments, further described below, third party domains 400 may be queried for additional information as a user vocally interacts with the interface of HMD 100.

HMD 100 may comprise an augmented reality display such as a monocular video see-through display, a bi-ocular video see-through display, a monocular optical see-through display, or a bi-ocular optical see-through display. Alternatively, HMD may comprise a VR display such as a video display that is not see-through. The HMD may be implemented in a variety of form factors such as, for example, a headset, goggles, a visor, or glasses. In one exemplary implementation, HMD 100 is a near-eye light-field display as described in U.S. patent application Ser. No. 15/089,308 titled “Near-Eye Light-Field Display System” and filed Apr. 1, 2016, which is incorporated herein by reference.

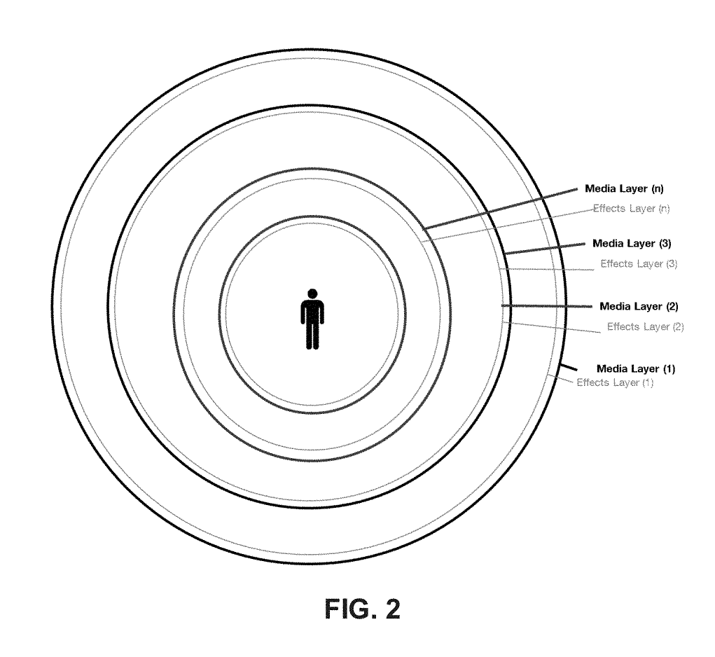

In various embodiments, HMD 100 provides a UI for providing an AR or VR environment associated with multi-layered media content (e.g., a multi-layered video). This multi-layered UI is visually illustrated by FIG. 2, which shows a plurality of media layers, each having an associated effects layer. The plurality of media layers may include—but are not limited to—video, audio, static images, motion graphics, data graphics, map information, environmental information and the like. Each effects layer governs one or more actions or effects that may be performed with respect to a corresponding media layer. For example, an effect may include—but is not limited to—a hide/show effect, a visual opacity effect, a visual blur effect, a color saturation effect, or an audio mute or equalization effect.

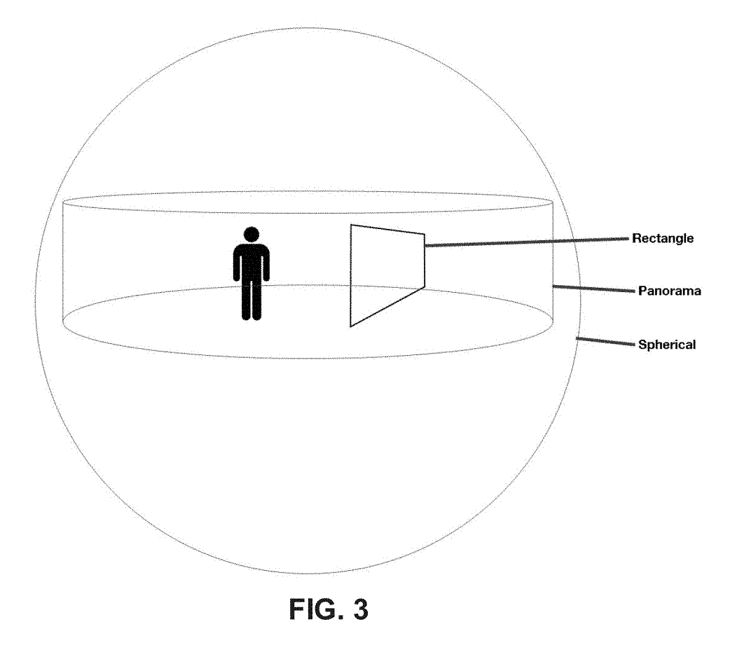

In embodiments, visual media layers may be represented by different fields of view, such as a two-dimensional display, a panoramic display, or a spherical display. For example, FIG. 3 illustrates a three visual media layer configuration, including a rectangular field of view, a 360-degree panoramic field of view, and a 360-degree spherical field of view, that may be implemented in embodiments.

As illustrated by the example of FIG. 3, the media layers, in various embodiments, may be overlaid over other media layer content, the user's real-world environment, or some combination thereof. For example, consider an AR environment in which three-dimensional digital graphics are registered and overlaid over the user's real-world environment. In this environment, the three-dimensional graphics may represent a first media layer overlaid over the user's real-world environment. In addition, a map (e.g., a second media layer) may be overlaid over the digital objects and real-world environment. For example, the map may be shown using a panoramic field of view. Further still, a fixed, context specific command menus (e.g., a third media layer) may be overlaid over the other media layers. For example, the fixed, content specific command menu may be represented using a fixed two-dimensional field of view.

As noted above, in the communication environment of FIG. 1, the multi-layered VR or AR content presented on HMD 100 may be dynamically manipulated, modified, or otherwise interacted with using vocal commands. More particularly, as a user interacts with multilayered content in real time, the user may issue voice commands that may affect individual or multiple media layers (e.g., by generating an effect associated with the media layer). Additionally, the voice commands may result in the creation of new media layers. In embodiments, the voice command may affect one or more media layers depending on the state of the media layer and/or the time of the voice command.

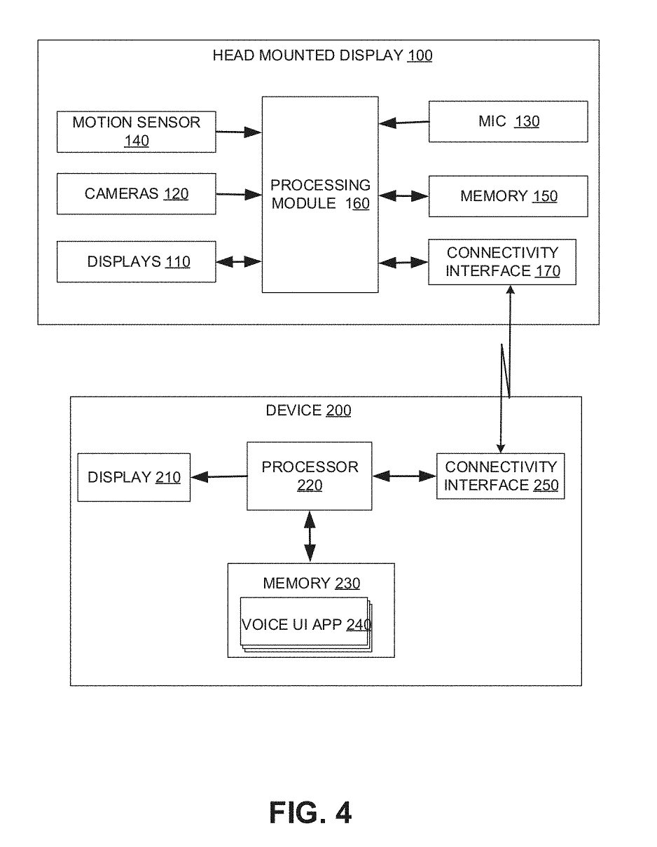

With specific reference now to HMD 100 and device 200, FIG. 4 is a block diagram illustrating an example architecture for components of HMD 100 and device 200 for implementing a voice-driven UI for controlling multi-layered content. In this example architecture, data processing tasks related to creation and interaction with the VR/AR environment, including generation of multi-layered media information in response to voice commands, are off-loaded to device 200.

It should be noted that in alternative implementations, HMD 200 may implement some or all data processing tasks related to creation and interaction with the VR/AR environment. For example, HMD 200 may itself execute a native application (e.g., an app that implements that functionalities of voice UI app 240, further described below) that takes voice as an input and output customized multi-layered integrated media information for display. Alternatively, HMD 200 may transmit vocal input to a web application or cloud application hosted by a server. The web application or cloud application may return the customized multi-layer integrated media information that is displayed.

HMD 100 may comprise one or more displays 110, one or more cameras 120, MIC 130, memory 140, motion sensors 150, processing module 160, and connectivity interface 170. Depending on the implementation of HMD 100, displays 110 may comprise video see-through displays, optical see-through displays, or video or optical displays that are not see-through (e.g., VR displays). Cameras 120, in various embodiments, are configured to capture the user's FOV in real time. The cameras may be positioned, for example, on the side of the user's head. Depending on the implementation of HMD 200, the cameras may include, for example, video cameras, light-field cameras, low-light cameras, or some combination thereof.

During operation, Microphone 130 receives vocal input (e.g., vocal commands for navigating multi-layered media) from a user of HMD 100 that is digitized and transmitted to device 200 for vocal navigation. In various embodiments, mic 130 may be any transducer that converts sound into an electric signal that is later converted to digital form. For example, mic 130 may be a digital microphone including an amplifier and analog to digital converter. Alternatively, processing module 160, may digitize the electrical signals generated by mic 130. In some implementations, mic 130 may be implemented in device 200 or a headset (e.g., earphones, headphones, etc.) connected to HMD 100 or device 200.

Motion sensor 140 may generate electronic input signals representative of the orientation of HMD 100. These electronic input signals may be received and processed by circuitry of processing module 160 to determine a relative orientation of HMD 100. In various embodiments, motion sensor 140 may comprise one or more gyroscopes, accelerometers, and magnetometers.

Memory 150 may comprise volatile memory (e.g. RAM), non-volatile memory (e.g. flash storage), or some combination thereof. In embodiments, memory 140 may store information obtained using cameras 120, mic 130, motion sensors 140, or some combination thereof. For example, audio information received by MIC 130 may be stored in memory 150 prior to transmission to device 200.

Connectivity interface 170 may connect HMD 100 to device 200 through communication link 300, using, for example, a BLUETOOTH connection, a ZIGBEE connection, a WiFi connection or the like. In further embodiments, connectivity interface 170 may connect HMD 100 to the internet using a cellular network, a satellite network or some combination thereof.

As shown, device 200 may comprise a display 210, processor 220, memory 230, and connectivity interface 250 that communicatively couples device 200 to HMD 100. In embodiments, device 200 can be any device that receives user voice as an input, and in response, outputs customized multi-layered integrated media information for display by the HMD. As shown in this example embodiment, memory 230 of device 200 stores a voice UI application 240, that when executed by processor 220, provides this functionality.

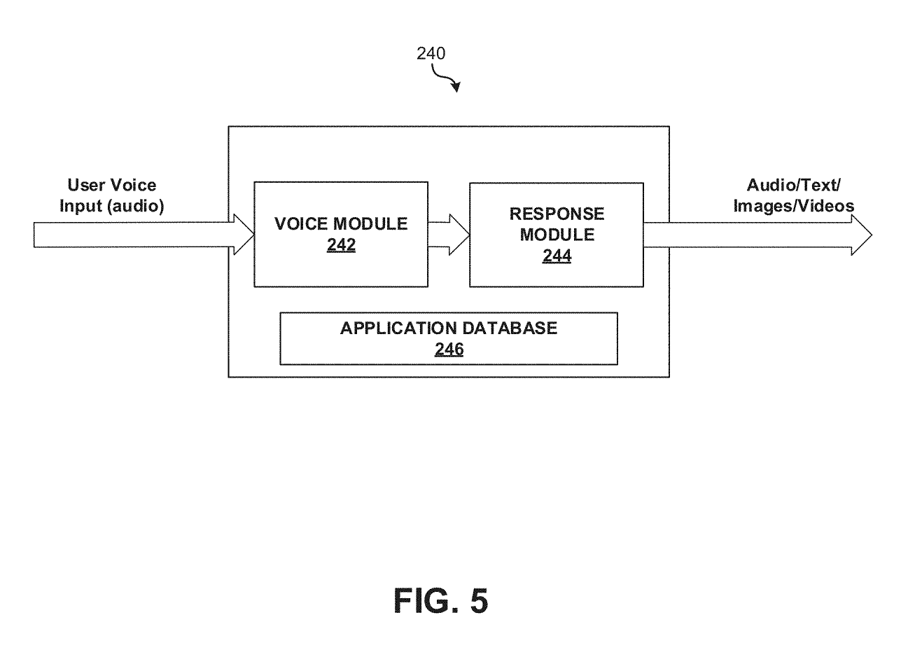

FIG. 5 illustrates example components of voice UI application 240 in accordance with embodiments. Voice UI application 240 receives as input digital audio information corresponding to a user voice command and outputs multi-layered integrated media information such as audio, text, images, video, and other information for playback by HMD 100. For example, after MIC 130 receives vocal input, the digital audio information may be transmitted from HMD 100 to device 200 over connectivity interface 170. In some embodiments, app 240 may also receive and process video information captured by cameras 120, and motion/positional information captured by motion sensor 140. For example, app 240 may process the received vocal input based on the received information captured by cameras 120.

In this embodiment, app 240 comprises a voice module 242, a response module 244, and a local or cloud-based database 246 for storing data. Voice module 242 receives user speech from a default microphone (e.g., MIC 130 of HMD 100, a microphone of device 200, or an audio headset connected to device 200), processes the speech to text, and generates text that can be interpreted. Response module 244 processes a relevant query result received from voice module 242 and defines an appropriate response in the form of multi-layered integrated media information. Local database 246, in various embodiments, stores metadata corresponding to multi-layered media content that is output by HMD 100. The metadata, in various embodiments, may comprise keywords, key phrases, verbs, content types, time or geo locators. Based on the combined relevance of the text of the voice input, an index of relevant media or a specific piece of media will be returned.

In one embodiment, app 240 may be configured to operate in an “awake mode” such that voice module 242 does not require a salutation every time a voice user interaction is requested. In this manner, the user may seamlessly interact with the multi-layered content using vocal commands, as the user no longer needs to initiate the salutation or wait for app 240 to confirm that it is listening. In implementations, the awake mode may be disabled by user vocal input or other user input (e.g., by accessing app 240 using display 210 of device 200).

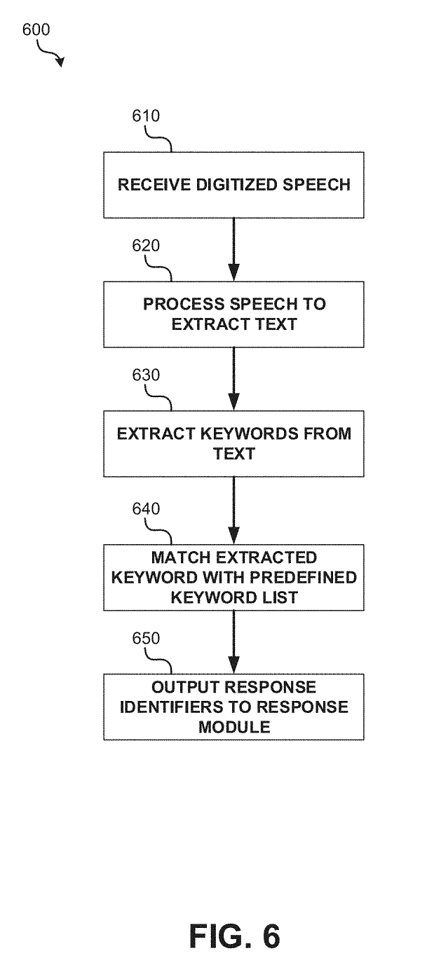

With reference now to voice module 242, FIG. 6 is an operational flow diagram illustrating a process 600 that may be implemented by voice module 242. At operation 610, a user's voice input (i.e., digitized speech) is received as an input. Subsequently, at operation 620, the speech is processed to extract text using speech recognition software engines known in the art. For example, natural language understanding (NLU) software development kits (SDK) such as API.AI SDK, CMU Sphinx, and the like may be used. At operation 630, keywords are extracted from the text using an automated speech recognition engine in conjunction with the NLU.

At operation 640, the extracted keywords are matched with a predefined keyword list to determine response identifiers associated with the media layers of the multi-layered media content being provided to the user using HMD 100. In various embodiments, each media layer may have an associated predefined keyword list that is stored in local or cloud-based database 246. For example, a media layer corresponding to a video of a geographical area may have keywords associated with the video such as the name of the geographical area, objects or animals that appear in the video, scenes in the video, and like information (e.g. Grand Canyon, Arizona, Colorado River, Mountain Goats, etc.). In embodiments, these objects, animals, scenes (or other keywords) may be chronologically indexed to the video (e.g., using time codes—the mountain goat appears at 1:24:43 of the Grand Canyon exploration video). As another example, a media layer corresponding to a Video Context Menu may have keywords associated with the different categories of the Context Menu.

In one embodiment, the creator of the multi-layered content may create the predefined keyword list. For example, a content creator may specify that input keywords of “Show Menu” correspond to an output response of showing a Video Context Menu. In one embodiment, third party domain services such as YouTube®, IMDB®, Wikipedia®, Google® Search and the like may also be invoked to determine response identifiers if the extracted keywords do not match the predefined keyword list. For example, if the keywords include a reference to a third party domain (e.g., In: “Show video of X on Third Party Service”), that domain may be accessed to perform a search for relevant results (e.g., Out: Search results of video from Third Party Service.)

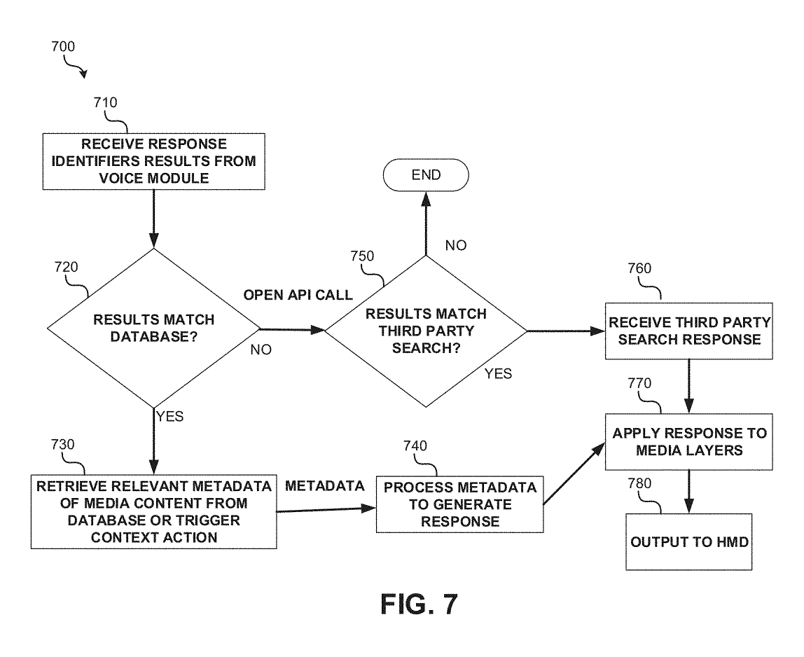

With reference now to response module 244, FIG. 7 is an operational flow diagram illustrating an example process 700 that may be implemented by response module 244. At operation 710, response identifier results are received from the voice module 242 as an input. In embodiments, response identifiers may comprise two context types: an app context type and an object context type. Table 1, below, illustrates examples response identifiers of the app context type and the object context type.

TABLE 1
Response Identifier Context Types

| | |
|---|---|
| 1. app context | “stop video”, “play video”, “pause |
| | video”, “exit”, “close menu” |
| 2. object context | “notes”, “maps”, “pictures”, “statistics” |

As shown, response identifiers of the “app context” type may be verbs or keywords that are matched against an action list in a database to trigger an action. For example, an application context action may be triggered in response to commands such as “Play Video”, “Pause Video”, “Next Video”, “Exit Video”, and the like. Response identifiers of the “object context” type may be keywords that will trigger response module to retrieve relevant metadata of multi-layered media content. For example, the “map” keyword may cause retrieval of geographic information/metadata stored in the database or retrieval of geographic information/metadata from a relevant third party search. The retrieved geographical information/metadata may be applied as a map layer on the media content.

At decision block 720, it is determined if the response identifier results match those stored in database 246. If the results match, at operation 730, depending on the match, the relevant metadata of the multi-layered media content is retrieved from local database 246 or an application context action may be triggered. For example, an app context action may be triggered in response to commands such as “Play Video”, “Pause Video”, “Next Video”, “Exit Video”, and the like.

At operation 740, the received metadata is processed to generate a response to be applied to the multi-layered content in response to the user's voice command. The response may create a new information layer (e.g., text, audio, and/or video) to be combined with the other media layers. For example, if the metadata corresponds to showing a Video Context Menu, the Video Context Menu may be combined with the other media layers (operation 770) and then output to the HMD (operation 780).

If, at decision block 720, it is determined that the response identifier results do not match those stored in local/cloud-based database 246, then a text query (e.g., an open API call) may be made to third party domain services to perform response identifier results matching. At decision 750, if it is determined that the query to the third party returns no match, then the process may end and no response may be output (i.e., no action is performed with the current multi-layered content in response to the user's vocal input). Alternatively, in some embodiments, if there is no match from the local/cloud-based database or the third party results, an information layer indicating that the user's vocal search yielded no results may be output as a response.

If there is a match from the third party search results, a response may be received from the third party (operation 760) and that response may be applied to the multi-layered content (operation 770) for output to the HMD (operation 780). For example, if an image is retrieved from a third party, that image may be overlaid over the multi-layered content (e.g., as a thumbnail).

In implementations, app 240 may generate a motion user interface over the multi-layered content, including textual keywords, audio prompts and haptic feedback for cueing the user to make voice initiated interactions. For example, the user may be given cues depending on the state of the multi-layered content (e.g., content currently being shown) and the amount of time that has passed since the user last initiated a voice interaction (e.g., to confirm that the user is still present).

In embodiments, app 240 may be implemented as a subcomponent (e.g., a module) of a multi-layered media content application that presents multi-layered media content to a head mounted display. Alternatively, app 240 may be called (e.g., by API request) by the multi-layered media content application. In these embodiments, an instance of the multi-layered media content application may be initialized prior to implementing the functions of app 240.

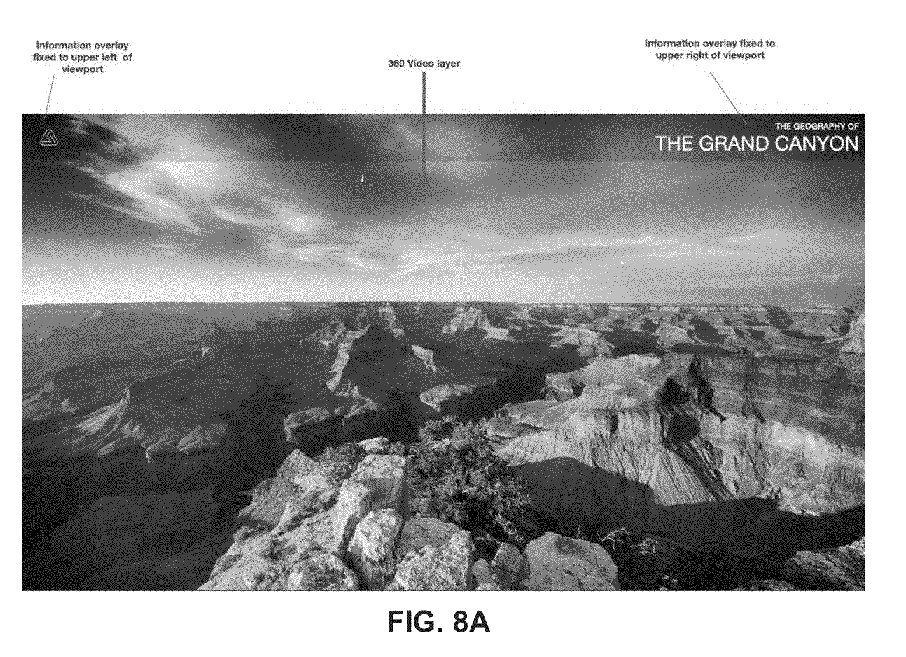

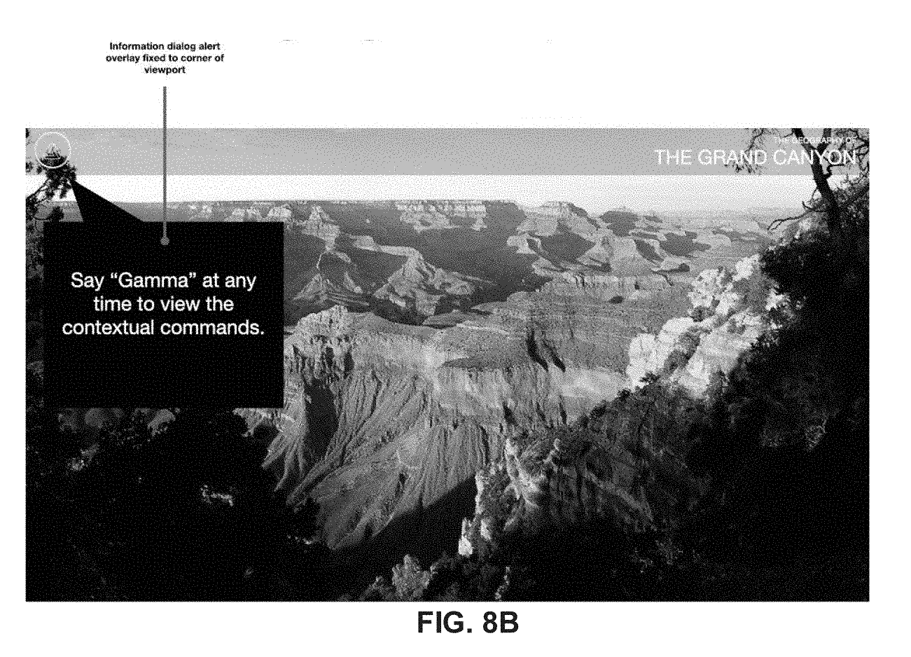

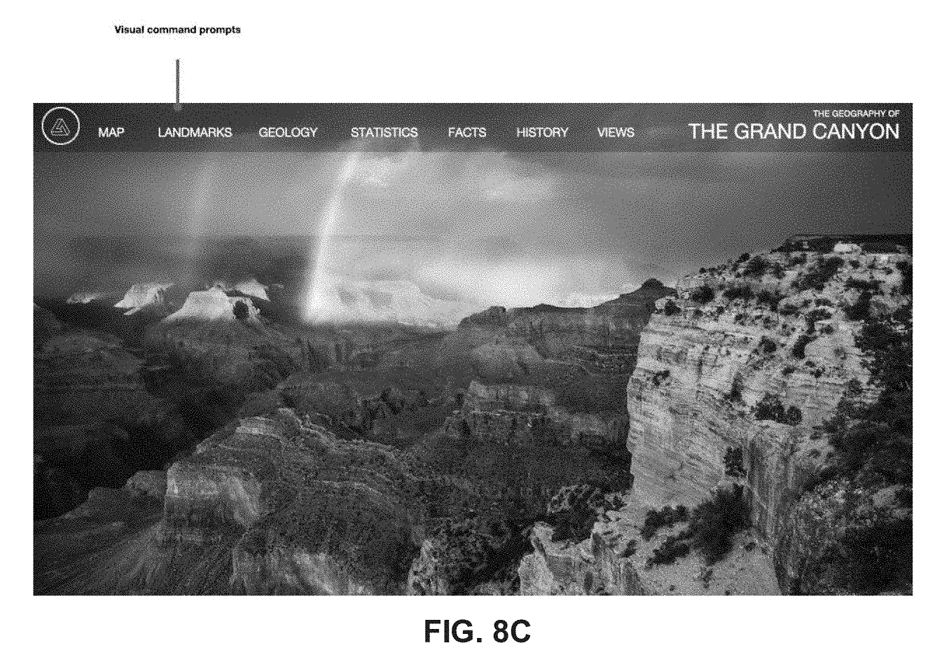

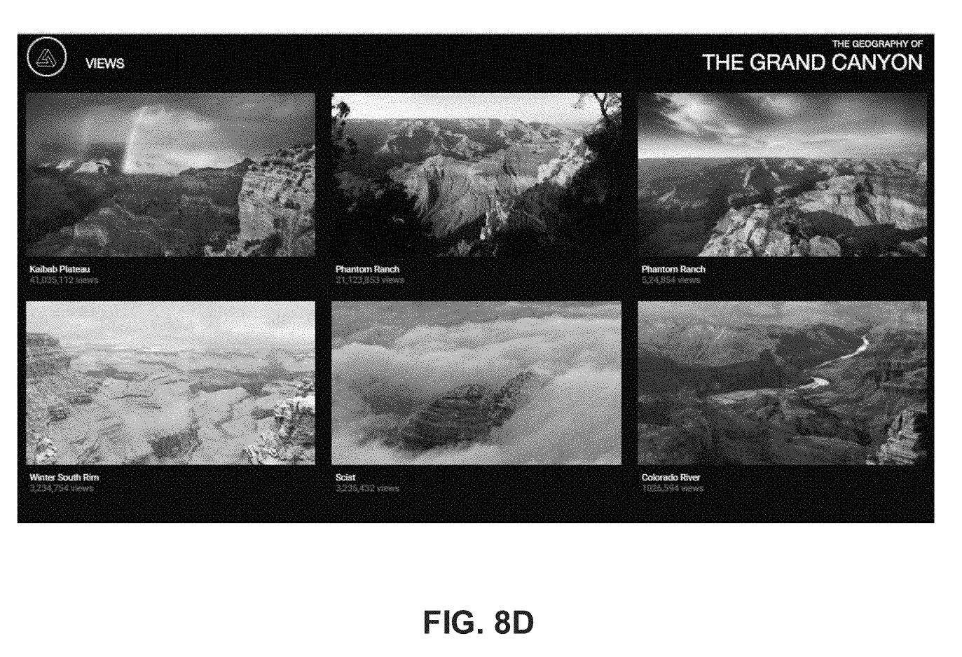

FIGS. 8A-8D illustrate an example voice-driven user interface for a HMD in which embodiments disclosed herein may be implemented. In this implementation, voice commands temporally linked to various media layers may be used to traverse a VR multi-layered content experience of the Grand Canyon, for example. The generation of multi-layered video information, including processing of vocal commands, in various embodiments, may be processed on a secondary device for display on the HMD or processed by the HMD.

Starting from FIG. 8A, a 360-degree video layer is displayed in the viewport of HMD. Additionally, information is overlaid and fixed to the upper left and upper right corners. In this example, the information identifies the VR experience as a tour through the geography of the Grand Canyon. At FIG. 8B, an information dialog alert is overlaid over the viewport. The dialog provides the user with a visual cue (i.e., “say ‘Gamma’ at any time to view the contextual commands”) for a voice command to begin voice interaction with the multi-layered media. Following the user's vocal command of “Gamma” or variants thereof, at FIG. 8C a menu layer including various visual command prompts (i.e., maps, statistics, views, etc. . . . ) is fixed to the top of the viewport. The menu layer provides the user with visual cues for voice initiating interactions that traverse the menu layer. Although illustrated as textual keywords in this example, in other embodiments a user may be cued to make voice initiated interactions using audio prompts or haptic feedback.

At FIG. 8D, following the input of a user vocal command to show views of the environment, a set of image thumbnails (i.e., views) are overlaid over the viewport over the “views” option.

In another example implementation, voice-driven control of multi-layered content may be used to display or read back speech-to-text dictation. For example, speech-to-text dictation may be implemented in response to the user filling out a web-based form, reviewing a list of notes or annotations to a document or video, or providing a summary of agreements and next steps from a video conference.

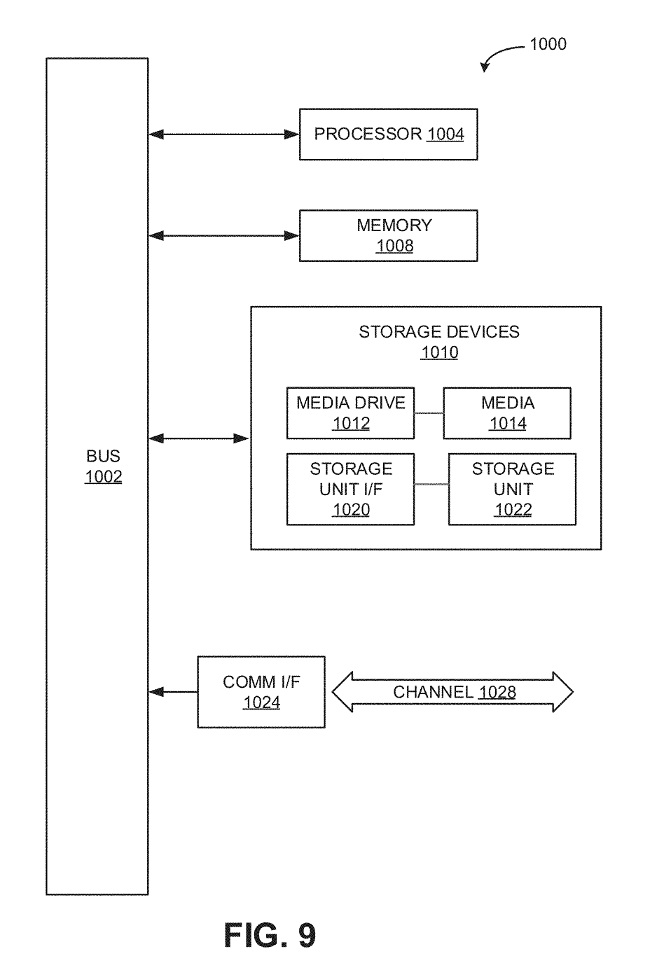

FIG. 9 illustrates an example computing module that may be used to implement various features of the methods disclosed herein.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 9. Various embodiments are described in terms of this example-computing module 1000. After reading this description, it will become apparent to a person skilled in the relevant art how to implement the application using other computing modules or architectures.

Referring now to FIG. 9, computing module 1000 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1000 might include, for example, one or more processors, controllers, control modules, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing module 1000 or to communicate externally.

Computing module 1000 might also include one or more memory modules, simply referred to herein as main memory 1008. For example, preferably random access memory (RAM) or other dynamic memory, might be used for storing information and instructions to be executed by processor 1004. Main memory 1008 might also be used for storing temporary variables or other intermediate information during execution of instructions to be executed by processor 1004. Computing module 1000 might likewise include a read only memory (“ROM”) or other static storage device coupled to bus 1002 for storing static information and instructions for processor 1004.

The computing module 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid state drive, a magnetic tape drive, an optical disk drive, a CD or DVD drive (R or RW), or other removable or fixed media drive might be provided. Accordingly, storage media 1014 might include, for example, a hard disk, a solid state drive, magnetic tape, cartridge, optical disk, a CD or DVD, or other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing module 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory module) and memory slot, a PCMCIA slot and card, and other fixed or removable storage units 1022 and interfaces 1020 that allow software and data to be transferred from the storage unit 1022 to computing module 1000.

Computing module 1000 might also include a communications interface 1024. Communications interface 1024 might be used to allow software and data to be transferred between computing module 1000 and external devices. Examples of communications interface 1024 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1024 might typically be carried on signals, which can be electronic, electromagnetic (which includes optical) or other signals capable of being exchanged by a given communications interface 1024. These signals might be provided to communications interface 1024 via a channel 1028. This channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer readable medium”, “computer usable medium” and “computer program medium” are used to generally refer to non-transitory media, volatile or non-volatile, such as, for example, memory 1008, storage unit 1020, media 1014, and transitory channels 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the present application as discussed herein.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. A method, comprising:
initializing an application instance for interacting with multi-layered media content output to a head-mounted display, wherein the multi-layered media content comprises a plurality of media layers;
receiving digitized speech and processing the digitized speech to extract text;
comparing one or more words from the extracted text with a predefined keyword list to determine a response identifier;
determining if the response identifier matches a response identifier stored in a database; and
if the response identifier matches a response identifier stored in the database, triggering an action in the application instance or retrieving from the database metadata associated with a media layer of the multi-layered media content.

2. The method of claim 1, further comprising: determining that the response identifier matches an application context response identifier stored in the database and triggering an action in the application instance.

3. The method of claim 1, further comprising: determining that the response identifier matches an object context response identifier stored in the database and retrieving from the database metadata associated with a media layer of the multi-layered media content.

4. The method of claim 3, further comprising: processing the metadata to generate a response to be applied to the multi-layered content for output to the head mounted display.

5. The method of claim 4, wherein the response creates a new information layer that is combined with other media layers of the multi-layered content.

6. The method of claim 1, wherein if the response identifier does not match a response identifier stored in the database, initiating a text query at the application instance to a third party domain service to perform response identifier matching.

7. The method of claim 1, further comprising: enabling an awake mode in the application instance such that a salutation is not required each time a user initiates a vocal interaction.

8. The method of claim 1, wherein the application instance displays a motion user interface over the multi-layered content, the motion user interface comprising a textual keyword, an audio prompt or haptic feedback that cues a user to make voice initiated interactions.

9. The method of claim 1, wherein the digitized speech is received from a microphone communicatively coupled to the head mounted display.

10. A non-transitory computer-readable medium having computer executable program code stored thereon, the computer executable program code configured to cause a system to:
initialize an application instance for interacting with multi-layered media content output to a head-mounted display;
receive digitized speech and processing the digitized speech to extract text;
compare one or more words from the extracted text with a predefined keyword list to determine a response identifier associated with a media layer of the multi-layered media content;
determine if the response identifier matches a response identifier stored in a database; and
if the response identifier matches a response identifier stored in the database, trigger an action in the application instance or retrieve from the database metadata associated with a media layer of the multi-layered media content.

11. The non-transitory computer-readable medium of claim 10, wherein the computer executable program code is configured to further cause the system to: determine that the response identifier matches an application context response identifier stored in the database and triggering an action in the application instance.

12. The non-transitory computer-readable medium of claim 10, wherein the computer executable program code is configured to further cause the system to: determine that the response identifier matches an object context response identifier stored in the database and retrieving from the database metadata associated with a media layer of the multi-layered media content.

13. The non-transitory computer-readable medium of claim 12, wherein the computer executable program code is configured to further cause the system to: process the metadata to generate a response to be applied to the multi-layered content for output to the head mounted display.

14. The non-transitory computer-readable medium of claim 13, wherein the response creates a new information layer that is combined with other media layers of the multi-layered content.

15. The non-transitory computer-readable medium of claim 10, wherein if the response identifier does not match a response identifier stored in the database, the computer executable program code is configured to further cause the system to initiate a text query at the application instance to a third party domain service to perform response identifier matching.

16. The non-transitory computer-readable medium of claim 9, wherein the digitized speech is received from a microphone communicatively coupled to the head mounted display.

17. A system, comprising:
a head-mounted display; and
a non-transitory computer-readable medium having computer executable program code stored thereon, the computer executable program code configured to cause the system to:
initialize an application instance for interacting with multi-layered media content output to the head-mounted display;
receive digitized speech and processing the digitized speech to extract text;
compare one or more words from the extracted text with a predefined keyword list to determine a response identifier associated with a media layer of the multi-layered media content;
determine if the response identifier matches a response identifier stored in a database; and
if the response identifier matches a response identifier stored in the database, trigger an action in the application instance or retrieve from the database metadata associated with a media layer of the multi-layered media content.

18. The system of claim 17, wherein the non-transitory computer-readable medium is a memory of the head-mounted display.

19. The system of claim 17, wherein the non-transitory computer-readable medium is a memory of a mobile device communicatively coupled to the head-mounted display.

20. The system of claim 17, wherein the non-transitory computer-readable medium is a memory of a server communicatively coupled to the head-mounted display.
